(19) United States
(12) Patent Application Publication
(10) Pub. No.: US 2007/0202840 A1
(43) Pub. Date: Aug. 30, 2007

(54) Mobile radio terminal and second subscription

(76) Inventor: William O. Camp JR., Chapel Hill, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/364,737

(22) Filed: Feb. 28, 2006

(51) Int. Cl. H04Q 7/20

(52) U.S. Cl. 455/403

(57) ABSTRACT

An electronic equipment for implementing at least a first service provided by a first service provider and a second service provided by a second service provider different from the first service provider includes a first service manger for regulating the electronic equipment with respect to the first service, wherein the electronic equipment may utilize services from both the first service and second service.

### TECHNICAL FIELD OF THE INVENTION

The present invention relates generally to the field of mobile radio terminals and, more particularly, to a method and apparatus that enables multiple subscription services on a single mobile radio terminal.

### DESCRIPTION OF RELATED ART

Mobile radio terminals, such as mobile phones, for example, can be used for a wide variety of applications. These applications can include basic applications such as voice communications over mobile networks, and advanced applications such as voice over internet protocol (VoIP), internet access via wireless network connections (WLAN), radio and/or television broadcasts (or podcasts), etc.

Presently, each of these applications are enabled and/or otherwise controlled by a mobile service provider (also referred to as a mobile operator), and typically are provided to a user's mobile phone via subscription to the mobile service provider's services. As used herein, a subscription refers to an agreement between a mobile radio terminal user and a service provider, wherein the service provider, in exchange for payment by the user, provides, controls and/or regulates one or more services on the user's mobile radio terminal. Generally, conventional mobile radio terminals do not manage or otherwise interact with mobile account activities. Instead, they simply provide an identification code (e.g., a telephone number via a Subscription Identification Module or SIM) and perform some encryption/decryption of data. All management functions typically are provided by the mobile service provider's system.

Referring to FIG. 1, a conventional mobile subscription service 10 is represented, wherein mobile service is provided by a mobile service provider 12. The mobile service provider 12 can choose to provide one or more services 14 to a user via mobile phone 16. Typically, the mobile service provider 12 will provide voice communication capabilities, and perhaps several other features, such as internet access, data transfer, and/or email capability, for example. However, if the mobile service provider 12 chooses not to offer a particular service, the user cannot obtain such service from other service providers, as the mobile phone 16 can accept only a single subscription, which in this example is tied to the mobile service provider 12. As a result, the user must either accept that the service is unavailable or shop for a new service provider.

### SUMMARY OF THE INVENTION

Emerging technologies and innovations in electronics certainly will result in additional features and/or applications (hereinafter referred to as features) for mobile radio terminals. However, in order for a user to obtain such features, they first must be made available by a service provider, such as a mobile service provider 12. As will be appreciated, implementation of new mobile radio terminal features typically requires an upfront investment by the service provider (e.g., new application software and/or infrastructure). Presumably, this investment will be returned as the number of subscriptions for the new service or services increases. For relatively small service providers, however, the customer base may be too small to justify implementation of some features. Similarly, certain features may not be in high demand and, thus, both small and large service providers may elect to forgo implementation of such features. Consequently, some mobile radio terminal users must either accept that these features are not available from their current service provider or shop for a new service provider.

The present invention enables a single mobile radio terminal, such as a mobile phone, to be associated with multiple subscriptions services. Moreover, each subscription service can be independent from other subscription services. Thus, for example, a user can subscribe to services provided by a first service provider, such as traditional voice communication services, and subscribe to services provided by a second service provider, such as radio and/or television subscription services, WLAN, VoIP, or any other service that may or may not be offered by the first service provider. In this manner, a user is not limited to the services offered by the first and/or second service provider.

Further, the services provided by the respective service providers may be activated, regulated, accessed and/or renewed via conventional mobile services (e.g., short message service (SMS), general packet radio service (GPRS)), WLAN, satellite, or any other communication medium accessible by the mobile radio terminal. Additionally, the services provided by the first and/or second service provider may be pre-configured with pre-paid subscriptions. This enables a mobile radio terminal vendor to sell phones with additional services that the first service provider may not wish to be involved in.

According to one aspect of the invention, an electronic equipment for implementing at least a first service provided by a first service provider and a second service provided by a second service provider different from the first service provider, comprises a first service manager for regulating the electronic equipment with respect to the first service, wherein the electronic equipment may utilize services from both the first service and second service. Further, the electronic equipment may be a mobile phone.

In one embodiment, the electronic equipment may include a second service manager for regulating the electronic equipment with respect to the second service. Additionally, the electronic equipment may include a first service processor communicatively coupled to the first service manager, and a second service processor communicatively coupled to the second service manager, wherein the first service manager independently regulates the first service processor such that the processor at least supports the first service, and the second service manager independently regulates the second service processor to at least support the second service. Further, the first service processor may render at least a portion the first service independent of the second service processor, and the second service processor renders at least a portion of the second service independent of the first service processor.

In another embodiment, the first and second service are at least one of a voice communication service, a television service, a radio service, an internet service, or a video communications service. Additionally, the voice communication service is a cellular phone service, a satellite phone service, or a VoIP service.

In yet another embodiment, the first and second services may be provided to the electronic equipment via a common medium. Further, the medium may be a cellular phone network, a satellite phone network, or a wireless local area network, or the medium may employ short message service or general packet radio service.

In another embodiment, the first and second service managers may perform at least one of service activation, service billing, service authorization, or service communications. Additionally, the first service and/or the second service may be prepaid subscriptions on the electronic equipment.

In yet another embodiment, the first service and the second service are different from one another. Additionally, the first service manager may obtain identification information relating to the second service and/or second service provider, and said first service manager notifies the second service provider of activation of the first service. The identification information may be at least one of an identifying number, a code, a name, or a tag of the second service, second service provider, and/or a user of the service.

In another embodiment, the first service and the second service may be provided over different mediums, and management of said services may be performed over a common medium.

According to another aspect of the invention, a method for implementing in electronic equipment a first service provided by a first service provider and a second service provided by a second service provider different from the first service provider, comprises: providing the first service to the electronic equipment; and providing the second service to the electronic equipment, wherein the second service is regulated on the electronic equipment such that the second service operates independently of the first service. Further, the electronic equipment may be a mobile phone.

In one embodiment, implementing the first service and the second service may include using services that are different from each other.

In yet another embodiment, the method may include using at least one of a voice communication service, a television service, a radio service, an internet service, or a video communications service as the first service and/or the second service. Further, using the voice communication service may include using a cellular phone service, a satellite phone service, or a VoIP service.

In another embodiment, the method may include using a common medium to implement the first service and second service. Further, using the common medium may include using a cellular phone network, a satellite phone network, or a wireless local area network as the medium. The medium may use short message service or general packet radio service.

In yet another embodiment, the method may include using the first and second service manager to perform at least one of service activation, service billing, service authorization, or service communications. Further, providing service billing may include automatically paying subscription fees.

In another embodiment, the method may further include providing the electronic equipment with a prepaid subscription to at least one service. The method also may include enabling one of the first service or second service and, at a predetermined time after enabling the one service, enabling the other of the first service or second service.

In yet another embodiment, the method may further include obtaining identification information relating to the second service and/or second service provider; and notifying the second service provider of activation of the first service. Additionally, identification information may be at least one of an identifying number, a code, a name, or a tag of the second service and/or user of the service.

In another embodiment, the method further comprises providing the first service and the second service over different mediums, and managing said services over a common medium.

According to another aspect of the invention, a computer program embodied in a computer readable medium for implementing in electronic equipment a first service provided by a first service provider and a second service provided by a second service provider different from the first service provider, comprises code that regulates the first service, wherein regulation of the first service is independent of the second service so as to enable independent operation of the first service and the second service.

According to yet another aspect of the invention, an electronic equipment for implementing at least a first service provided by a first service provider and a second service provided by a second service provider, comprises a first service manger for regulating the electronic equipment with respect to the first service, wherein regulation of the first service is independent of the second service so as to enable independent operation of the first service and second service. Additionally, the first service provider and the second service provider may be the same entity.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic diagram illustrating a conventional implementation of a subscription service for a mobile radio terminal.

FIG. 2 is a schematic diagram illustrating an exemplary implementation of a multi-subscription service on a single mobile radio terminal in accordance with the invention.

FIG. 3 is a block diagram illustrating an exemplary communications network that can be used with the invention.

FIG. 4 is a block diagram of an exemplary mobile radio terminal with multi-subscription capability in accordance with the invention.

FIG. 5 is a block diagram illustrating exemplary functions performed by a primary or secondary service manager in accordance with the invention.

FIG. 6 is an exemplary flow chart illustrating a method for multi-subscription service on a mobile radio terminal in accordance with the invention.

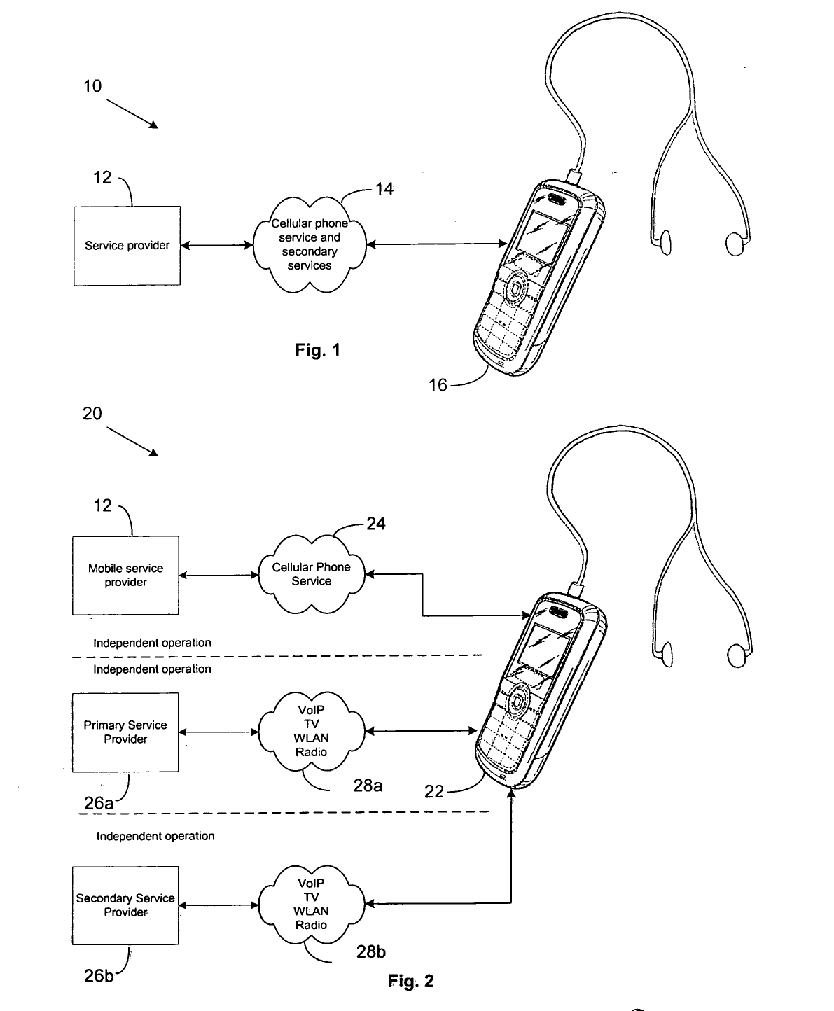

### DETAILED DESCRIPTION OF EMBODIMENTS

The term “electronic equipment” includes portable radio communication equipment. The term portable radio communication equipment, which hereinafter is referred to as a mobile radio terminal, includes equipment such as mobile telephones, communicators, e.g., electronic organizers, personal digital assistants (PDAs) smart phones or the like. The term “regulate” as used herein is defined as to control or direct based on one or more criteria.

The present invention enables electronic equipment, such as mobile radio terminals, to subscribe to multiple service providers. Moreover, each subscription can be independent of other subscriptions. This enables a first service provider to provide a first service or services to the mobile radio terminal, and a second service provider to provide a second service or services to the mobile radio terminal, wherein the first service provider can regulate the first services independent of the second service provider, and the second service provider can regulate the second services independent of the first service provider.

Referring to FIG. 2, there is provided a schematic diagram illustrating a mobile radio terminal 22 configured to accept subscriptions from three different service providers. As will be appreciated, the mobile radio terminal 22 can be configured to accept more or less than three subscriptions, and only three subscriptions are shown for sake of clarity. Also, while the invention is described with respect to subscriptions provided by different service providers, it is conceivable that a single service provider may access the mobile radio terminal via two or three different subscriptions.

A mobile service provider 12 provides a mobile service or services 24 to the mobile radio terminal 22. The mobile services typically include voice communications via a mobile network, such as a cellular network, for example, and may include other features. Further, a primary service provider 26a provides a primary service or services 28a to the mobile radio terminal 22. The primary services may include internet access, email access, VoIP, WLAN, television and/or radio broadcasts, video communication services, etc. As will be described in more detail below, the mobile radio terminal 22 includes a primary service manager that interfaces with the primary service provider's system. The primary service manager enables the primary service provider 12 to regulate the primary services provided to the mobile radio terminal 22. This can include, for example, access to the primary service provider's infrastructure, activation of features within the mobile radio terminal 22, billing, etc.

Additionally, a secondary service provider 26b, who may operate independent of the primary service provider 26a and/or the mobile service provider 12 (e.g., a separate organization not affiliated with the primary service provider and/or the mobile service provider), provides a secondary service or services 28b to the mobile radio terminal 22. The mobile radio terminal 22 also includes a secondary service manager that interfaces with the secondary service provider's system. Like the primary service manager above, the secondary service manager enables the secondary service provider 26b to regulate the secondary services 28b provided to the mobile radio terminal 22.

The secondary services 28b may include services different from the primary services 28a, services that are the same as the primary services 28a or any combination thereof. For example, the primary services 28a may include VoIP, while the secondary services 28b may include receiving television broadcasts or podcasts. Alternatively, the services 28a, 28b may be the same. For example, both the primary services 28a and the secondary services 28b may comprise television podcasts or voice communications (e.g., mobile or ViOP). This may be useful, for example, if the mobile radio terminal user frequently travels between two or more different regions, wherein the primary services 28a provide coverage in the first region but not in the second region, and the secondary services 28b provide coverage in the second region but not the first region.

Further, the primary and secondary services may be provided over a common medium or over different mediums. Similarly, management of the primary and secondary services also may be over a common medium or over different mediums. For example, the primary service may be provided over a mobile phone network, while the secondary services may be provided over a wireless computer network. However, both services may be managed over the mobile phone network (e.g., billing, subscription status, activation, etc.).

The mobile radio terminal 22 can be pre-configured with pre-paid subscriptions to the primary and/or secondary service. In this manner, a mobile radio terminal vender may sell mobile radio terminals 22 with additional services that the mobile, primary and/or secondary service providers 12, 26a, 26b may not wish to be involved with. Further, the timing of the secondary (or primary) subscription can be after the user has purchased the mobile radio terminal (e.g., after he has left the store), or when a subscription service becomes available (e.g., a new television channel comes online). The actual trigger event for notifying the user could be in-band (e.g., conveyed by the television service to the service manager), or it can arrive over an outside channel (e.g., SMS, email, mobile network, etc.). The respective service managers can query the new owner of the mobile radio terminal 22 some time after the purchase, wherein the user is given the opportunity to enable the service. The respective service manager then would proceed to configure the service and install any required software, e.g., digital rights management software to enable viewing of encrypted video and/or audio content.

It is noted that the terms primary and secondary as used herein with respect to the service providers, service managers and service processors, is not necessarily intended to signify one is dominant over the other. Instead, the terms are merely used to differentiate between the respective service providers and devices. Further, while mobile phone services and/or services providers are not referred to herein as either a primary or secondary service or service provider, it is to be understood that mobile services and/or service providers may be considered a primary or secondary service or service provider.

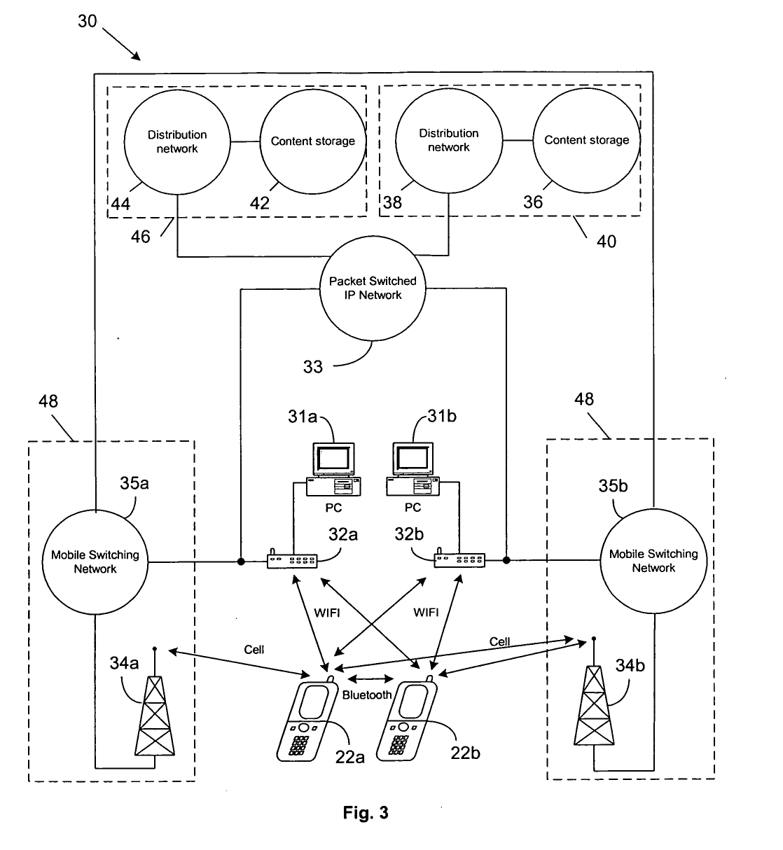

Referring now to FIG. 3, there is shown an exemplary schematic diagram 30 illustrating various communication mediums and systems that can be used with electronic equipment embodied as mobile phones. A first and second mobile phone 22a and 22b can exchange data via a number of different conduits. For example, data can be directly transferred between the respective phones using a Bluetooth communication link. Alternatively, data can be transferred from the first mobile phone 22a to a first PC 31a, a second PC 31b and/or the second mobile phone 22b, and vice-versa, via a WLAN (also referred to as WIFI) connection using a wireless router 32a and 32b and/or a packet switched IP network 33 (e.g., the internet, a local area network, a wide area network, etc.). Additionally, data may be transferred from the first mobile phone 22a to the first PC 31a, the second PC 31b or the second mobile phone 22b, and vice-versa, via a mobile communication link using towers 34a and 34b and mobile switching networks 35a and 35b. As will be appreciated, a number of other connections may be established that are not shown in FIG. 3. For example, a Bluetooth communication link may be established between the mobile phones 22a and 22b and the PCs 31a and 31b.

Also shown in FIG. 3 is a content storage medium 36, which can store various media content, such as radio or television podcasts, for example. Further, a distribution network 38 provides a means for distributing the media content to electronic devices, such as the mobile phones 22a and 22b. The storage medium 36 and the distribution network 38 can comprise a system 40 of the primary service provider 26a. A second storage medium 42 and distribution network 44, which also can store and distribute various media content, can comprise a system 46 of the secondary service provider 26b. Additionally, the towers 34a, 34b and mobile switching network 35a, 35b can comprise a system 48 of a mobile communications provider (e.g., a mobile phone service provider 12).

In operation, a user of the mobile radio terminal 22a may subscribe to a mobile phone service via the mobile communications provider's system 48 to provide mobile phone (e.g., voice) communications, for example. Thus, the mobile radio terminal 22a may communicate with another mobile radio terminal 22b, with PCs 31a, 31b, and the packet switched IP network 33. It is noted that access to the system 48 can be regulated via the mobile phone service provider's system 48, with little interaction by the mobile radio terminal 22a. The user, however, also desires radio and/or television features on the mobile radio terminal 22a, which are not offered by the mobile service provider 12. According to the invention, the user may subscribe to another service provider (e.g., a primary and/or secondary service provider) that does provide these features, while at the same time maintaining the subscription to the mobile service provider 12. The mobile radio terminal 22a then can access the primary service provider's system 40 via the mobile service provider's system 48 or via another system (e.g., wireless routers 32a, 32b, which may or may not be part of the primary and/or secondary service provider's system). As will be appreciated, any combination of features can be packaged in the primary and secondary services. The combinations may be mutually exclusive or they may overlap or even be identical. For example, the primary services may include email access and VoIP, while the secondary services may include VoIP and video conferencing. In another example, both services include VoIP and internet access. In a third example, the primary service includes internet access while the secondary service includes video conferencing communications.

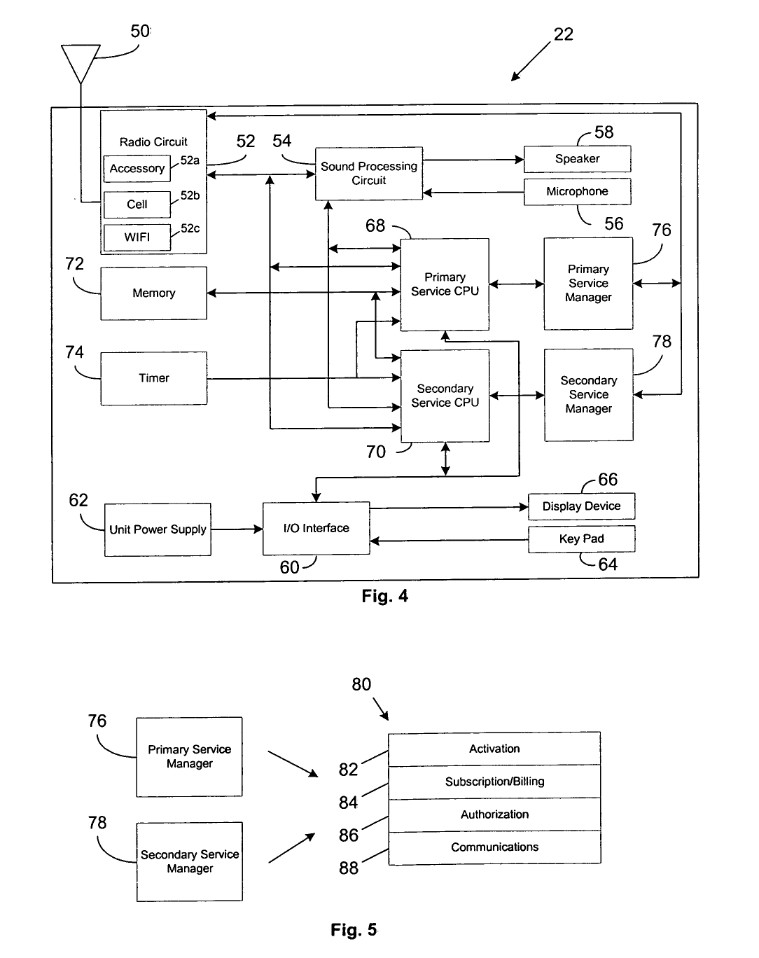

Moving now to FIG. 4, a block diagram of an exemplary mobile radio terminal 22 is shown. The mobile radio terminal 22 includes an antenna 50 operatively coupled to a radio circuit 52. The radio circuit 52 can include an accessory transceiver or receiver 52a (e.g., Bluetooth, television, satellite or other wireless communications technique) for communicating with other devices (e.g., an accessory or other electronic equipment), a conventional mobile phone transceiver 52b for communicating via a conventional mobile phone network (e.g., via towers or satellite), and an optional wireless network transceiver 52c (also referred to as WIFI or WLAN) for wirelessly communicating with a LAN or WAN, for example. Although not shown, it will be appreciated that separate antennas may be provided for each of the respective radio circuits 52a, 52b and 52c. The mobile radio terminal also includes a sound processing circuit 54, which, in conjunction with a microphone 56 and speaker 58, enable sound to be input and output from the mobile radio terminal 22. Further, an I/O interface 60 distributes power from a power supply 62 (e.g., a battery) to the various sections of the mobile radio terminal 22, and the I/O interface 60 receives data from a key pad 64 and provides data to a display 66. The radio circuit 52, sound processing circuit 54 and I/O interface 60 are operatively coupled to a primary service processor 68 and a secondary service processor 70, which, in conjunction with memory 72 and timer 74, executes code stored in memory 72 so as to implement the mobile radio terminal functionality, e.g., wireless voice communications, recognition of keypad entries, display control, WLAN interface, data transfer, accessory communications, etc. A primary service manager 76 is communicatively coupled to the primary service processor 68 and the radio circuit 52, while a secondary service manager 78 is communicatively coupled to the secondary service processor 70 and the radio circuit 52. While separate processors 68, 70 are shown, it will be appreciated that a single processor can be implemented in place of the two separate processors.

The primary service manager 76 interfaces with the primary service provider's system 40 (e.g., via the radio circuit 52) and the primary service processor 68, while the secondary service manager 78, independent of the primary service manager 76, interfaces with the secondary service provider's system 46 (e.g., also via the radio circuit 52) and the secondary service processor 70. More specifically, the primary service manager 76 communicates with the primary service provider's system 40 so as to obtain information regarding the operation of the primary service (e.g., configuration, authorization, etc.), as will be discussed in more detail below. The primary service manager 76 then provides at least a portion of the information to the primary service processor 68, such that the primary service processor 68 supports and/or renders the primary service or services in the mobile radio terminal 22. As the primary service processor 68 implements the primary service, the primary service processor 68 is monitored and/or regulated by the primary service manager 76.

Similarly, the secondary service manager 78 communicates with the secondary service provider's system 46 so as to obtain information regarding the operation of the secondary service. The secondary service manager 78 then provides at least a portion of the information to the secondary service processor 70, such that the secondary service processor 70 supports and/or renders the secondary service or services in the mobile radio terminal 22, independent of the primary service processor 68. As the secondary service processor 70 implements the secondary service, the secondary service processor 70 is monitored and/or regulated by the secondary service manager 78.

As will be appreciated, the primary and secondary service managers can be implemented via hardware (e.g., logic circuits), software (e.g., a program executed by the respective service processor) and/or firmware. Further, while separate primary and secondary processors 68, 70 are shown, a single processor can be used to implement both primary and secondary functionality (e.g., separate logical processes in software). Also, and although not shown, it will be appreciated that a conflict resolver may be implemented to mediate simultaneous access to circuits of the mobile radio terminal 22 by the primary and secondary service manager 76, 78 as well as the primary and secondary processors 68, 70.

Accordingly, multiple service providers can provide services to the mobile radio terminal 22, wherein each service provider can operate independent of the other, and each service provider's actions are executed independent of the other.

With further reference to FIG. 5, a block diagram 80 is provided that illustrates exemplary functions performed by the primary and secondary service managers 76, 78. One function that can be implemented by the service managers 76, 78 is activation of the respective services, as indicated at block 82. Activation can include enabling the service in the mobile radio terminal 22 (e.g., configuring the terminal to be recognized by the service provider's system 40, 46 and/or to recognize the service provider's system 40, 46). For example, information, such as access codes, identification codes, account numbers, or the like, may be provided by the service provider's system 40, 46 that enable access to the respective system. This information can be used by the service manager to configure the mobile radio terminal 22 such that it can use and/or access the particular service. In contrast, activation for a mobile communications network typically is implemented by the mobile service provider's system 48, with little intervention by the mobile radio terminal 22.

Moving to block 84, another function that can be performed by the service managers 76, 78 is billing or payment for the service. For example, billing can be implemented directly by the mobile radio terminal 22, wherein payment reminders are provided on the display 66. The user, via the keypad 64 and display 66, then can pay the bill using a credit card, for example. Alternatively, credit card information can be securely stored on the mobile radio terminal 22, and when a bill for service becomes due, the respective service manager 76, 78 can retrieve the credit card information and automatically pay the bill. Further, safeguards can be implemented in the service managers 76, 78 to ensure improper use of the auto billing feature is not abused and/or subject to erroneous charges. For example, a maximum charge amount can be entered into the mobile radio terminal 22, such that a single payment and/or all payments do not exceed the maximum charge. Billing also can be implemented via a secure website and/or via telephone, both of which can be supported by the respective service manager 76, 78.

Block 86 illustrates the authorization function that can be performed by the service managers 76, 78. Authorization includes determining whether the mobile radio terminal 22 is authorized or allowed to access the service or system 40, 46. For example, the service manager 76, 78 may store data in the mobile radio terminal memory 72 and/or receive data from the service provider's systems 40, 46, wherein the data is related to system access. This data can include account expiration dates, download limits, maximum minutes allowed, current minutes used, etc., any of which may be related to system access. The service managers 76, 78 then can compare the maximum values to the actual values to determine whether or not to allow the mobile radio terminal to access the respective system 40, 46. For example, if a particular subscription allows 400 minutes of use per month, and 300 minutes actually have been used, then, since all of the minutes have not been used, the service manager authorizes access. If, however, 400 minutes have been reached or exceeded, then the service manager will deny access. As will be appreciated, the primary and/or secondary service provider, in addition to the service manager, also may determine whether the mobile radio terminal 22 is authorized to access the systems 40, 46, and an encryption/decryption key.

Block 88 illustrates the communication function of the service managers 76, 78. Communications, for example, includes transmitting and receiving data to/from the service provider's systems 40, 46 as well as to/from the respective service processors 68, 70. Data transferred to/from the mobile radio terminal 22, including data transfers to/from the primary service manager 76 and secondary service manager 78, can be via the mobile service provider's system 48 (which may use conventional mobile services such as SMS, GPRS, etc.), a WLAN interface, a satellite interface, a Bluetooth interface, or any communication medium available to the mobile radio terminal 22. Moreover, the data can be data related to activation, renewal and/or even delivery of the service itself (including both the primary and secondary services). For example, a secondary service 28b provided by a secondary service provider 26b can be activated, renewed or even transmitted using the mobile network operated by the mobile service provider. Further, communications may include decryption and/or digital rights management processes.

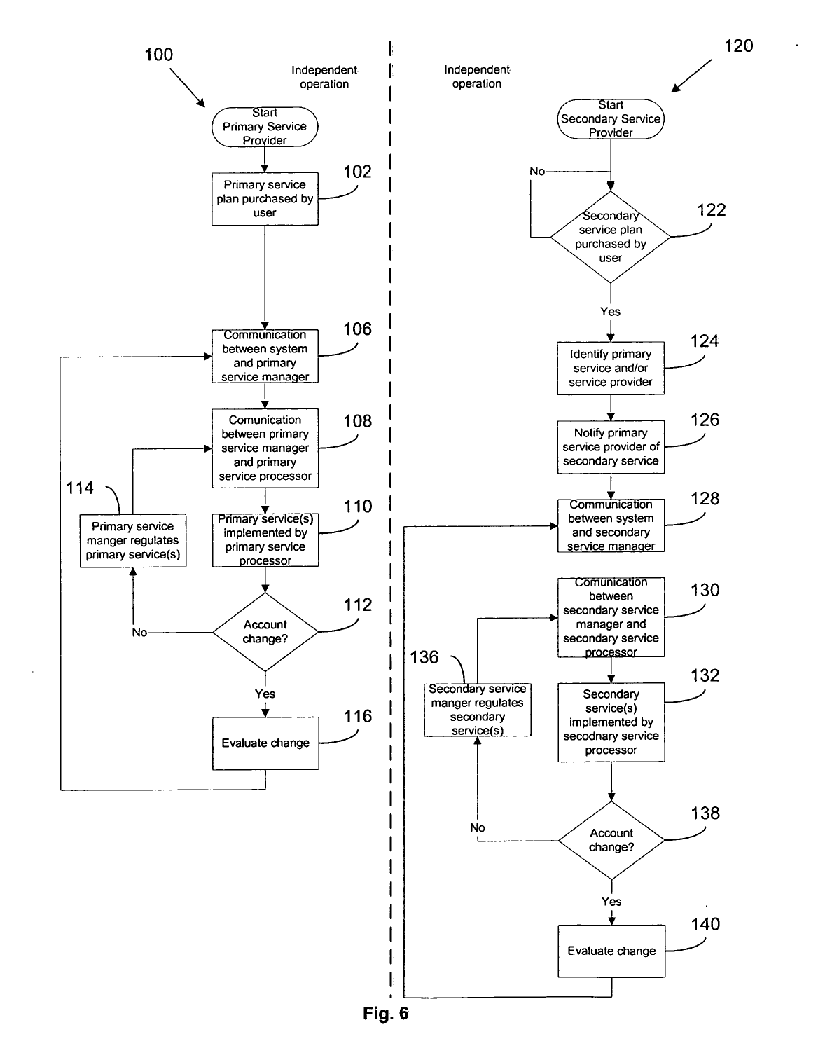

Moving now to FIG. 6, there is provided flow diagrams 100 and 120 illustrating the independent operation of the primary and secondary service managers 76, 78. The flow diagrams include a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence. Also, it is presumed that the user already has a mobile phone with a service plan, such as a mobile communications service plan, for example.

Beginning at step 102 of the method 100, a service plan, such as a television plan, for example, is purchased by a user, and at step 104, the primary service provider's system 40 communicates with the primary service manager 76 so as to provide configuration data to the mobile phone 22. At step 108, the primary service manager 76 communicates the information to the primary service processor 68, which then proceeds to implement instructions from the primary service manager 76, as indicated at step 110 (e.g., activation). At this point, the terminal is activated and the user may execute its features.

At step 112, it is determined if a change has been made to the account. A change may be implemented by the user (e.g., a request to change subscription parameters such as allowed time, maximum download, etc.), by the service manager 76 (e.g., a pre-allotted limit of the subscription has been exceeded), or by the system 40 (e.g., a new feature has been made available). If an account change has not been made, then the method moves to step 114 and primary service manager 76 regulates the primary service. Regulation can include functions such as renewal/billing, authorization, and communications as discussed herein, as well as general operations (e.g., communications with the system 40 and/or other devices in the mobile phone 22, housekeeping, etc.). If an account change has been made, then at step 116 the particular change is determined and the method moves back to step 106 to implement the change and continue operation.

Moving now to the method 120 for the secondary service provider, at step 122 it is determined if a secondary service has been purchased. A purchase, for example, can be initiated by the user, or can be prompted by a notification by the secondary service manager 78 (via a pre-paid subscription or a message from the secondary service provider's system 46). If the user chooses not to purchase the secondary subscription, the method loops indefinitely at step 122. Meanwhile, the method 100 continues to execute independent of the method 120 and independent of any mobile service plan.

If the user does decide to purchase or otherwise activate the secondary subscription, then at optional step 124 the secondary service manager 78 identifies the mobile service provider 12, the primary service 28a and/or primary service provider 26a. Identification can include, for example, obtaining an account number, telephone number, tag, code, name, or any other information that can identify the mobile service provider 12, the primary service provider 26a, the primary service 28a, and/or the user of the mobile radio terminal. Next, at optional step 126 the secondary service manager 78, either directly, through the mobile service provider's system 48 or the primary service manager 76, notifies the mobile service provider 12 and/or the primary service provider 26a that the secondary service 28b has been activated. This is advantageous, for example, in that the mobile service provider 12 and/or the primary service provider 26a may be able to receive some revenue from the secondary service provider 26b (e.g., share the cost of subsidizing the phone to the user). The revenue may be in the form of a one time payment or it may be ongoing for as long as the secondary service is active.

Next, the method proceeds to implement the secondary service via steps 128-140, which are substantially the same as steps 106-116 of the method 100, except communications are now between the secondary system, secondary service manager and secondary processor. Further, both the primary service and the secondary service operate independent of one another, and can be controlled by different service providers (e.g., the primary service provider 26a and the secondary service provider 26b).

Accordingly, a device and method for enabling multi-subscriptions to be associated with a single mobile radio terminal has been disclosed. The invention is advantageous, for example, in that it enables mobile radio terminal users to select one or more service providers. Thus, a user may select a first service, such as voice communications service, from a first service provider, and a second service, such as television reception, from a second service provider, wherein each service can be independent of the other.

Specific embodiments of an invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electronic equipment for implementing at least a first service provided by a first service provider and a second service provided by a second service provider different from the first service provider, comprising a first service manager for regulating the electronic equipment with respect to the first service, wherein the electronic equipment may utilize services from both the first service and second service.

2. The device of claim 1, further comprising a second service manager for regulating the electronic equipment with respect to the second service.

3. The device of claim 2, further comprising a first service processor communicatively coupled to the first service manager, and a second service processor communicatively coupled to the second service manager, wherein the first service manager independently regulates the first service processor such that the processor at least supports the first service, and the second service manager independently regulates the second service processor to at least support the second service

4. The device of claim 3, wherein the first service processor renders at least a portion the first service independent of the second service processor, and the second service processor renders at least a portion of the second service independent of the first service processor.

5. The device of claim 2, wherein the first and second service are at least one of a voice communication service, a television service, a radio service, an internet service, or a video communications service.

6. The device of claim 5, wherein the voice communication service is a cellular phone service, a satellite phone service, or a VoIP service.

7. The device of claim 2, wherein the first and second services are provided to the electronic equipment via a common medium.

8. The device of claim 7, wherein the medium is a cellular phone network, a satellite phone network, or a wireless local area network.

9. The device of claim 7, wherein the medium employs short message service or general packet radio service.

10. The device of claim 2, wherein the first and second service managers perform at least one of service activation, service billing, service authorization, or service communications.

11. The device of claim 1 wherein the first service and/or the second service are prepaid subscriptions on the electronic equipment.

12. The device of claim 1, wherein the first service and the second service are different from one another.

13. The device of claim 1, wherein the electronic equipment is a mobile phone.

14. The device of claim 1, wherein the first service manager obtains identification information relating to the second service and/or second service provider, and said first service manager notifies the second service provider of activation of the first service.

15. The device of claim 14, wherein the identification information is at least one of an identifying number, a code, a name, or a tag of the second service, second service provider, and/or a user of the service.

16. The device of claim 1, wherein the first service and the second service are provided over different mediums, and management of said services is performed over a common medium.

17. A method for implementing in electronic equipment a first service provided by a first service provider and a second service provided by a second service provider different from the first service provider, comprising:
providing the first service to the electronic equipment; and
providing the second service to the electronic equipment, wherein the second service is regulated on the electronic equipment such that the second service operates independently of the first service.

18. The method of claim 17, wherein implementing a first service and a second service includes using services that are different from each other.

19. The method of claim 17, further comprising using at least one of a voice communication service, a television service, a radio service, an internet service, or a video communications service as the first service and/or the second service.

20. The method of claim 19, wherein using a voice communication service includes using a cellular phone service, a satellite phone service, or a VoIP service.

21. The method of claim 17, further comprising using a common medium to implement the first service and second service.

22. The method of claim 21, wherein using a common medium includes using a cellular phone network, a satellite phone network, or a wireless local area network as the medium.

23. The method of claim 21, further comprising using a short message service or general packet radio service.

24. The method of claim 17, wherein the electronic equipment is a mobile phone.

25. The method of claim 17, further comprising using a first and second service manager to perform at least one of service activation, service billing, service authorization, or service communications.

26. The method of claim 25, wherein providing service billing includes automatically paying subscription fees.

27. The method of claim 17, further comprising providing the electronic equipment with a prepaid subscription to at least one service.

28. The method of claim 17, further comprising enabling one of the first service or second service and, at a predetermined time after enabling the one service, enabling the other of the first service or second service.

29. The method of claim 17, further comprising:
obtaining identification information relating to the second service and/or second service provider; and
notifying the second service provider of activation of the first service.

30. The method of claim 29, wherein the identification information is at least one of an identifying number, a code, a name, or a tag of the second service and/or user of the service.

31. The method of claim 17, further comprising:
providing the first service and the second service over different mediums; and
managing said services over a common medium.

32. A computer program embodied in a computer readable medium for implementing in electronic equipment a first service provided by a first service provider and a second service provided by a second service provider different from the first service provider, comprising code that regulates the first service, wherein regulation of the first service is independent of the second service so as to enable independent operation of the first service and the second service.

33. An electronic equipment for implementing at least a first service provided by a first service provider and a second service provided by a second service provider, comprising a first service manger for regulating the electronic equipment with respect to the first service, wherein regulation of the first service is independent of the second service so as to enable independent operation of the first service and second service.

34. The device of claim 33, wherein the first service provider and the second service provider are the same entity.
